(19) United States
(12) Patent Application Publication
(10) Pub. No.: US 2011/0211330 A1
(43) Pub. Date: Sep. 1, 2011

(54) Lighting apparatus

(76) Inventor: Wen Wen Wang, Taoyuan County (TW)

(21) Appl. No.: 12/660,625

(22) Filed: Mar. 1, 2010

(51) Int. Cl. F21V 19/04

(52) U.S. Cl. 362/20

(57) ABSTRACT

A lighting apparatus comprises at least one LED module, a light frame, a base plate, a battery, a cover plate, at least two end caps, and a fixture assembly. The base plate is received in the light frame. The LED module is mounted on the base plate. The battery is received in the light frame and electrically connected to the base plate. The cover plate is deposited on a bottom portion of the light frame. The end caps are assembled to two ends of the light frame. The fixture assembly serves to fix the lighting apparatus to a wall or a ceiling. When the lighting apparatus loses the external power supply, by operating a power switch connected to the lighting apparatus, the battery can be controlled to take over powering, with power stored therein, the LED module on the base plate to illuminate for a predetermined time period.

### BACKGROUND OF INVENTION

1. Field of the Invention

The present invention relates to lighting apparatuses, and more particularly to a lighting apparatus installed therein a battery that serves to take over powering the lighting apparatus for a predetermined time period after a normal external power supply is down.

2. Description of the Prior Art

With the development of illumination technology, the criteria of future lighting sources are not only focused on the lighting deficiency, but also directed to effective lighting, comfortable lighting, biological lighting, safe lighting, environmentally friendly lighting and resource-preserving lighting. In view of this, it is expectable that LED lighting devices will show a great market potential and have increasingly expanding applications as well as market share. With the specially advantageous photoelectric properties, safety properties, and environmentally friendly properties, LED lighting devices are likely to soon fully supersedes the traditional light sources and become the revolutionary lighting approach for the coming generations.

There are various existing LED lighting devices, designed for different use occasions and illuminance, which are supported by light-emitting diodes (LEDs) of different numbers and power levels. Generally, operation, namely illumination, of these LED lighting devices requires power supplied by a grid power source. However, in case of power failure, despite in a matter of the traditional lighting devices or of the LED lighting devices, illumination can only cease.

Therefore, it would be desired to provide an approach to allowing an LED lighting apparatus to illuminate for a prolonged time period by operating a power switch when a grid power source connected to the LED lighting apparatus is suddenly down, and in such case, the LED lighting apparatus also serves as a substitute of an indoor emergency light so as to save the cost for purchasing such indoor emergency light.

### SUMMARY OF INVENTION

The primary objective of the present invention is to provide a lighting apparatus which has a battery settled in a light frame thereof, so that when the grid power source is suddenly down, the battery takes over powering the lighting apparatus for illumination with power stored therein.

Another objective of the present invention is to provide a lighting apparatus, which uses a fixture assembly to be fixed to a wall or a ceiling, with a light-emitting angle of the lighting apparatus adjustable.

For achieving these objectives, the present invention provides the lighting apparatus including at least one LED module, a light frame, a base plate, a battery, a cover plate, at least two end caps, and a fixture assembly.

The light frame has a top portion, a bottom portion, and a hollow portion. The top portion is provided with a pair of corresponding lengthwise grooves, while the bottom portion is provided with a recessed accommodating space and another pair of corresponding lengthwise grooves. The base plate allows the LED module to be such installed thereon that the base plate is received in the accommodating space of the light frame and the LED module faces an opening of the accommodating space.

The battery is received in the hollow portion of the light frame and electrically connected to the base plate. The cover plate is deposited on the bottom portion of the light frame and inlaid in the lengthwise grooves of the bottom portion. The end caps are assembled to two ends of the light frame so as to enclose the base plate on which the LED module is fixed in the accommodating space of the light frame and enclose the battery in the hollow portion of the light frame. The fixture assembly serves to fix the lighting apparatus to a wall or a ceiling.

When the lighting apparatus loses the external power supply, by operating a power switch connected to the lighting apparatus, the battery can be controlled to take over powering, with power stored therein, the LED module on the base plate to illuminate for a predetermined time period.

### BRIEF DESCRIPTION OF THE DRAWINGS

The present invention as well as a preferred mode of use, further objectives and advantages thereof will best be understood by reference to the following detailed description of illustrative embodiments when read in conjunction with the accompanying drawings, wherein:

FIG. 1 is an exploded view of a lighting apparatus according to a first preferred embodiment of the present invention;

FIG. 2 is a perspective view of the lighting apparatus according to the first preferred embodiment of the present invention;

FIG. 3 is a cross-sectional view of the lighting apparatus according to the first preferred embodiment of the present invention, taken along Line B-B;

FIG. 4 is an applied view of the lighting apparatus according to the first preferred embodiment of the present invention;

FIG. 5A is an operational block diagram of the lighting apparatus according to the first preferred embodiment of the present invention;

FIG. 5B is a circuit diagram of the lighting apparatus according to the first preferred embodiment of the present invention;

FIG. 6 is a perspective view of a lighting apparatus according to a second preferred embodiment of the present invention;

FIG. 7 is an exploded view of a lighting apparatus according to a third preferred embodiment of the present invention;

FIG. 8 is a perspective view of the lighting apparatus according to the third preferred embodiment of the present invention; and

FIG. 9 is a cross-sectional view of the lighting apparatus according to the third preferred embodiment of the present invention, taken along Line B-B.

### DETAILED DESCRIPTION OF THE PREFERRED EMBODIMENT

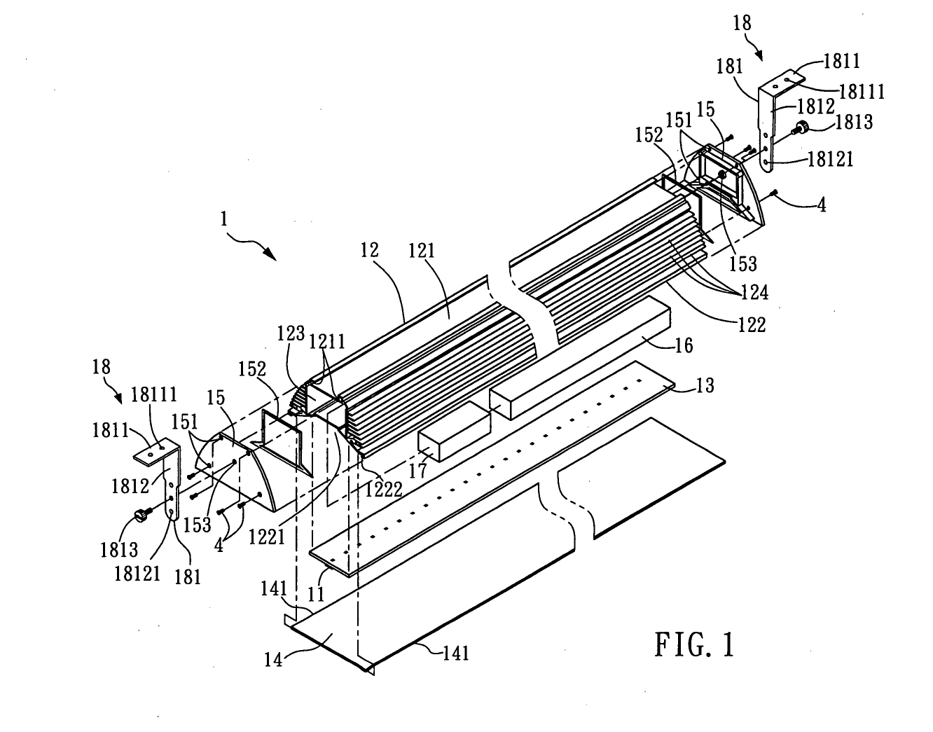

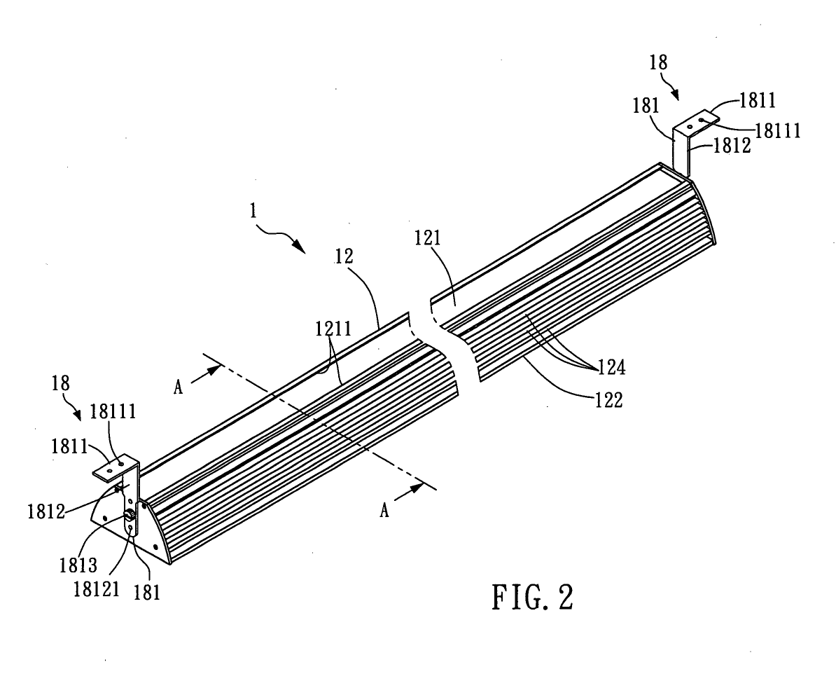

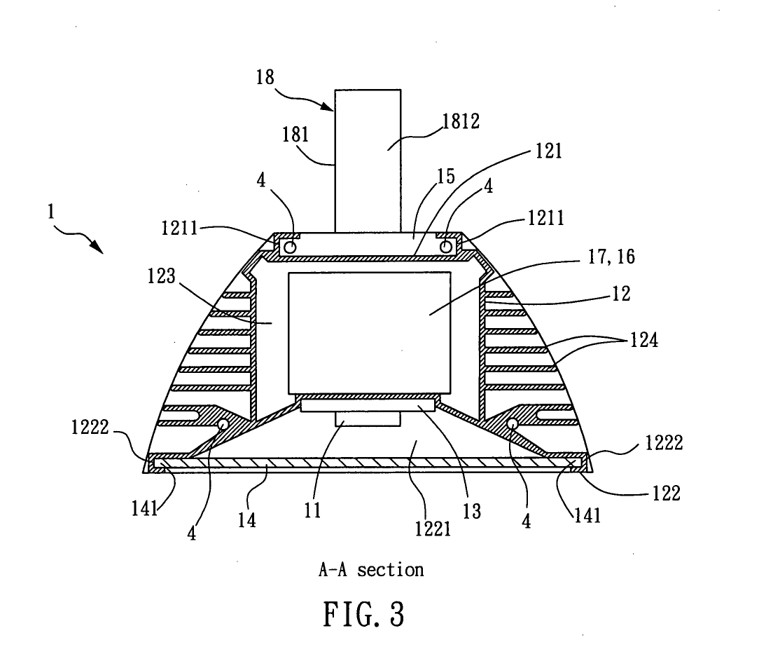

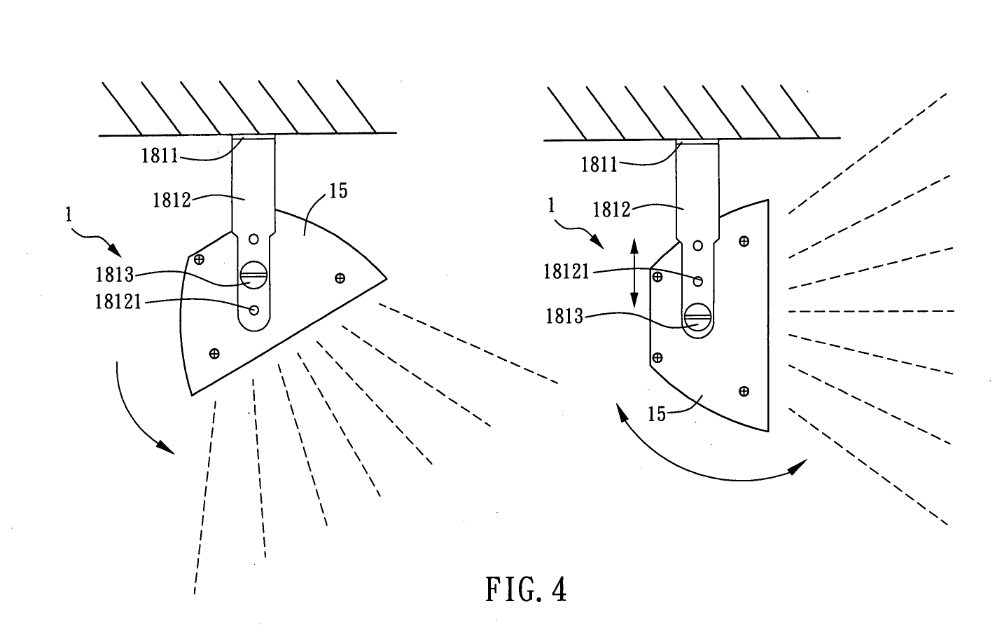

Referring to FIGS. 1, 2, 3 and 4, according to a first preferred embodiment of the present invention, a lighting apparatus 1 is composed of at least one LED module 11, a light frame 12, a base plate 13, a cover plate 14, at least two end caps 15, a battery 16, a power control module 17 and a fixture assembly 18.

The light frame 12 is a lengthwise frame formed through an aluminum extrusion process or an aluminum die-casting process, and includes: a top portion 121, a bottom portion 122, and a hollow portion 123. The top portion 121 is provided with a pair of corresponding lengthwise grooves 1211, while the bottom portion 122 is provided with a recessed accommodating space 1221 and a pair of corresponding lengthwise grooves 1222. The light frame 12 is formed bilaterally with a plurality of plate-shaped sink fins 124 that are equidistantly spaced and aligned. These sink fins 124 serve to increase the heat-dissipation area for the LED module 11, and in turn improve the heat-dissipation efficiency of the light frame 12 itself.

In the first preferred embodiment of the present invention, the base plate 13 is a printed circuit board (PCB), which may be made from a metal base plate (such as an aluminum base plate or a copper base plate) or may be a non-metal PCB. The base plate 13 is provided with at least one circuit loop, and is configured to allow the LED module 11 to be such installed thereon that the base plate 13 is received in the accommodating space 1221 of the light frame 12 and the LED module 11 faces an opening of the accommodating space 1221. Of course, the base plate 13 may be positioned in the accommodating space 1221 and attached to the light frame 12 by means of wedging, screw-coupling, inlaid coupling, or adhesion, so that the base plate 13 is enabled to pass the heat generated by the LED module 11 to the light frame 12. While any of the foregoing fixing technologies is known in the art, no further description related thereto will be given herein.

The cover plate 14 is a transparent cover plate located on the bottom portion 122 of the light frame 12 with two lengthwise edges defined as two combining edges 141 for coupling with the lengthwise grooves 1222, respectively, in order to not only prevent invasion of foreign matters or dust from, but also streamline the appearance of the apparatus by hiding the internal components. The cover plate 14 may be a convex lens, a concave lens, a plane lens, or an optical diffuser plate. The cover plate 14 may be a clear, frosted or colored transparent plate.

Each of the end caps 15 further has: a plurality of threaded holes 151, a water-block washer 152 and a combining hole 153. The end caps 15 are attached to two ends of the light frame 12 by means of a plurality of fastening screws 4 coupled with the threaded holes 151, so that the LED module 11 and the base plate 13 coupled therewith are received in the accommodating space 1221 while the battery 16 and the power control module 17 are enclosed in the hollow portion 123 of the light frame 12. The water-block washer 152 is sandwiched between the corresponding end cap 15 and the light frame 12 for preventing moisture from invading the accommodating space 1221 and the hollow portion 123 of the light frame 12. The water-block washer 152 may be made of rubber or silica gel.

The battery 16 is a rechargeable battery settled in the hollow portion 123 of the light frame 12 and electrically connected to the power control module 17, so as to act as the emergency power supply for the LED module 11. The battery 16 may be a Ni—Cd battery, a Ni—H battery or a Li battery. The power control module 17 is deposited in the hollow portion 123 of the light frame 12 and electrically connected to the base plate 13 and the battery 16, respectively, for voltage transformation and current rectification.

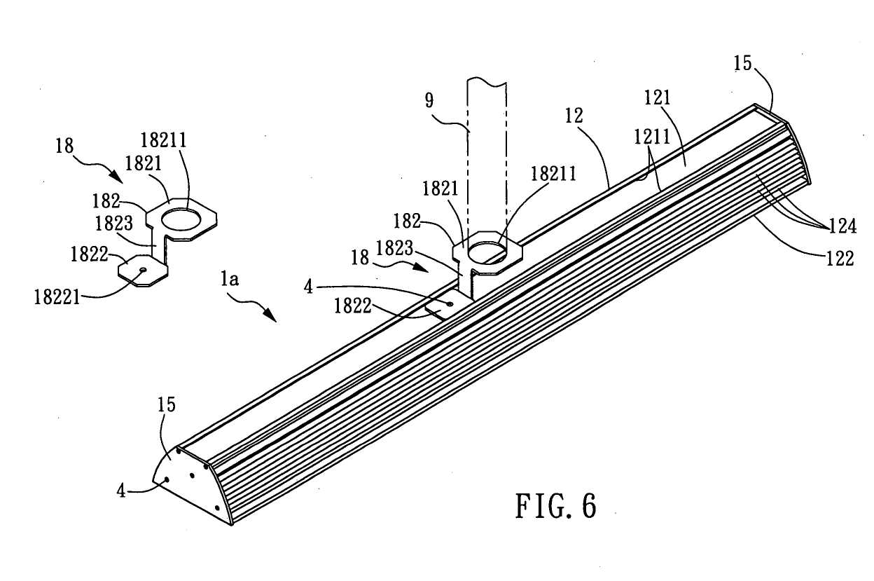

The fixture assembly 18 serves to attach the lighting apparatus 1 to a wall or a ceiling, and includes: at least one adjustable arm 181 and at least one fixed arm 182 (shown in FIG. 6). In the first preferred embodiment of the present invention, the fixture assembly 18 is composed of two said adjustable arms 181. The adjustable arms 181 are assembled to the two end caps 15 of the lighting apparatus 1, and each of them includes: a fixing end 1811, a combining end 1812 and an adjuster 1813.

The fixing end 1811 and the combining end 1812 are approximately perpendicular to each other. The fixing end 1811 is preformed with at least one through hole 18111 for allowing the fixing end 1811 to be fixed to a wall or a ceiling. The combining end 1812 is provided with a plurality of positioning holes 18121 allowing the adjuster 1813 to pass and then couple with the combining hole 153 of the corresponding end cap 15, in which manner the light-emitting angle of the LED module 11 settled in the light frame 12 and the distance between the light frame 12 and the wall or the ceiling it is attached to can be both adjusted.

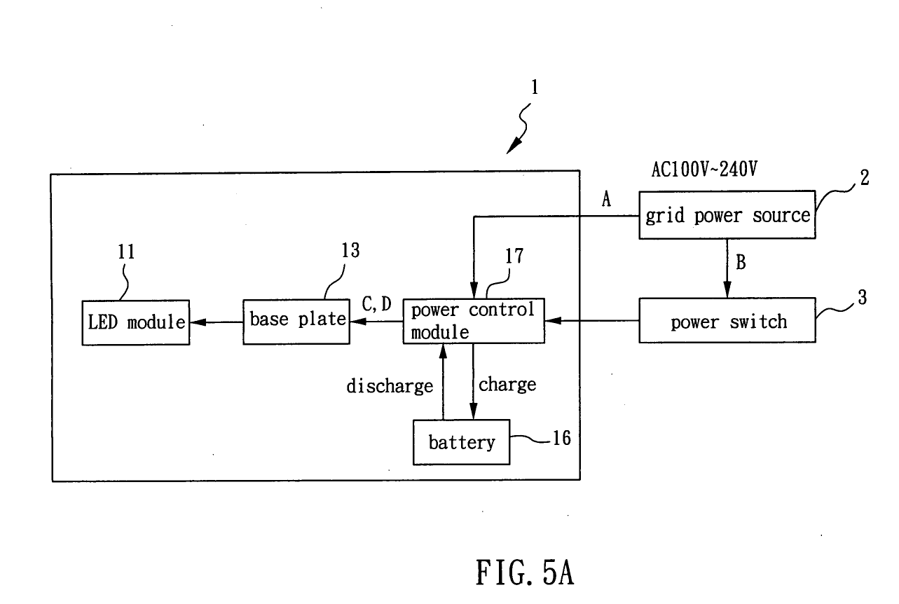

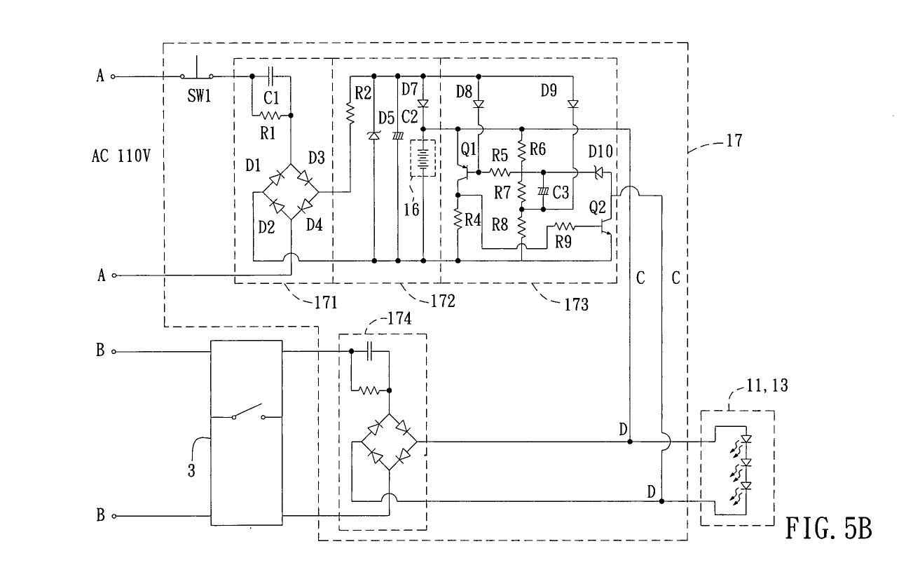

Referring to FIG. 5A, therein, the power control module 17 of the lighting apparatus 1 is electrically connected to a grid power source 2 (110V˜240V, i.e. the master power switch) and a power switch 3, respectively. The power control module 17 converts an alternating current (AC) of 110V or 240V from the grid power source 2 into a direct current (DC), for a control circuit in the power control module 17 to turn on the power switch 3 and thereby actuate the lighting apparatus 1 for illumination.

In case of sudden failure or breakdown of the grid power source 2, the lighting apparatus 1 can still illuminate with the power from the built-in battery 16 that takes over powering the LED module 11. When the grid power source 2 is restored later on, the grid power source 2 can then proceed with powering the LED module 11 for illumination and charge the battery 16 for replenishing the power stored therein.

Referring to FIG. 5B, therein, the power control module 17 further comprises: a first power circuit 171, a charging circuit 172, a control circuit 173 and a second power circuit 174. The first power circuit 171 and the second power circuit 174 have the same layout.

The first power circuit 171 has its input end directly connected to the external grid power source 2 along a power route A, for converting the alternating current AC into the direct current DC. In a preferred embodiment, the first power circuit 171 further includes a transformer circuit (not shown in this figure) in order to transform the 110V (or 240V) current into a lower voltage level, such like (but not limit to) 50V, 12V or 9V. Similarly, the second power circuit 174 can also be furnished with the same transformer circuit when the first power circuit 171 has it. There are a capacitor C1 and a resistor R1 connected in parallel and then connected to bridge rectifiers D1˜D4. Since the capacitor C1 itself serves to limit the current and the resistor R1 acts as the discharge resistor for capacitor C1 that has consumed the power stored in the capacitor C1 during the failure of the grid, the bridge rectifiers D1˜D4 serve to convert the alternating current into the direct current and output it to the charging circuit 172.

The charging circuit 172 stabilizes and filters the direct current output by the first power circuit 171 so as to charge the battery 16. In the charging circuit 172, there are connected in parallel a resistor R2 for current limitation and a Ziner diode D5 for voltage stabilization, a filter capacitor C2, the battery 16 and a diode D7 that is connected in series at one end of the battery 16 for preventing reverse current.

The control circuit 173 serves to detect whether the power of the grid power source 2 coming along the power route A is cut. If yes, the battery 16 supersedes the grid power source 2 to act as the main power source and outputs the power therein to the base plate 13 and the LED module 11 along a power route C. The control circuit 173 connects an emitter and a collector of a transistor Q1 with the battery 16 in parallel. The collector of the transistor Q1 is further connected in series with a resistor R4. A base of the transistor Q1 is connected with a diode D8 that is connected to an input end of the charging circuit 172, and the same base is further connected with a resistor R5 that has its the other end connected with several divider resistors R6˜R8, a capacitor C3 and a cathode of a Ziner diode D10. The resistor R7 and the capacitor C3 have their the other ends connected with a diode D9 that is connected to an input end of the charging circuit 172. The collector of the transistor Q1 is connected to a base of another transistor Q2 while a collector and an emitter of the transistor Q2 is connected to an anode of the Ziner diode D10 and the cathode of the battery 16, respectively.

The second power circuit 174 and the first power circuit 171 have the same layout, both serving to convert the alternating current into the direct current. However, the second power circuit 174 has its input end connected to the grid power source 2 through the power switch 3 along a power route B, and has its output end directly connected to the base plate 13 and the LED module 11 (D power route).

In other words, as shown in FIG. 5B, the power control module 17 has joints A and B electrically connected with the grid power source 2 (AC 110V), respectively. Thus, the lighting apparatus 1 of the present invention may operate in three different power supply modes, as described below.

In the first mode, the grid power source 2 supplies power normally and the power switch 3 is off. At this time, the direct current DC from the first power circuit 171 flow along through the charging circuit 172 to charge the battery 16. The control circuit 173 now does not output any current, meaning that the power routes C and D output no current, so the LED module 11 is off. Optionally, in another embodiment, another diode (not shown) may be connected in series to the power route C of FIG. 5B, so as to prevent the current from flowing reversely from the power route D through the power route C to the control circuit 173.

In the second mode, the grid power source 2 supplies power normally and the power switch 3 is on. At this time, the control circuit 173 does not output any current to the power route C, while there is the direct current from the second power circuit 174 in the power route D, so the LED module 11 illuminates normally.

In the third mode, the grid power source 2 ceases supplying power. At this time, no matter the power switch 3 is currently on or off, the control circuit 173 outputs the current to the power route C, so as to allow the LED module 11 illuminates for emergency illumination.

Additionally, the Ziner diode D5 of the charging circuit 172 also serves to limit the full voltage of the battery 16. In other words, once the voltage at the Ziner diode D5 is equal to that of the battery 16, the diode D7 stops the current from charging the battery 16 any more. Moreover, normally, voltages at the emitter and the base of the transistor Q1 are the same, so the transistor Q1, and in turn the transistor Q2, are off. Meantime, the resistor R5˜R8 of the control circuit 173 and the capacitor C3 jointly form a power-fault detection circuit. Since power can be supplied through the diode D9, the loop is standing by for immediate operation once power fault of the grid power source 2 is detected.

In case of power fault of the grid power source 2 or when a switch SW1 is turned off to disable the first power circuit 171, the battery 16 serves to power the circuit. Meanwhile, there is no current passing through the diode D9 of the control circuit 173, and the capacitor C3 has a short circuit at the moment of charge, so the transistor Q1 is turned on due to the lowered potential of the base. As a result, the resistor R4 has a voltage sag, so as to turn on the transistor Q2 and prompt the load of the next stage, namely the LED module 11, to operate. Meantime, beyond the transistor Q2, the resistor R6 and the Ziner diode D10 form a voltage stabilizing circuit, and the current is provided to the base of the transistor Q1 through the resistor R5. Since the default voltage of the Ziner diode D10 is lower than the voltage of the battery 16, the operation of the transistor Q1 can be continuously supported.

In the other preferred embodiments of the present invention described hereinafter, since most elements are the same as or similar to those in the aforementioned embodiment, like elements will be referred to by like names and numbers, and an extra alphabet will be appended to the original number for similar elements having the same name without any particular mention.

Referring to FIG. 6, in a second preferred embodiment of the present invention, a lighting apparatus 1a has a fixture assembly 18 in the form of a said fixed arm 182. The fixed arm 182 is composed of two fixing members arranged into a stepped arm. Such a fixed arm 182 includes: an upper fixing member 1821, a lower fixing member 1822, and a connecter 1823.

The connecter 1823 is connected between the upper fixing member 1821 and the lower fixing member 1822. The upper fixing member 1821 is provided with a fixing hole 18211 for a fixing post 9 extending from a ceiling to couple therewith. The lower fixing member 18 has its periphery inlaid into the grooves 1211 at the top portion 121 of the light frame 12. In such case, the thickness of the lower fixing member 18 substantially fits the inner width of the grooves 1211, and the distance between the corresponding grooves 1211 substantially fits the width of the lower fixing member 18, so that the fixed arm 182 can be fastened to the light frame 12 by coupling a screw 4 with a through hole 18221 formed on the lower fixing member 1822.

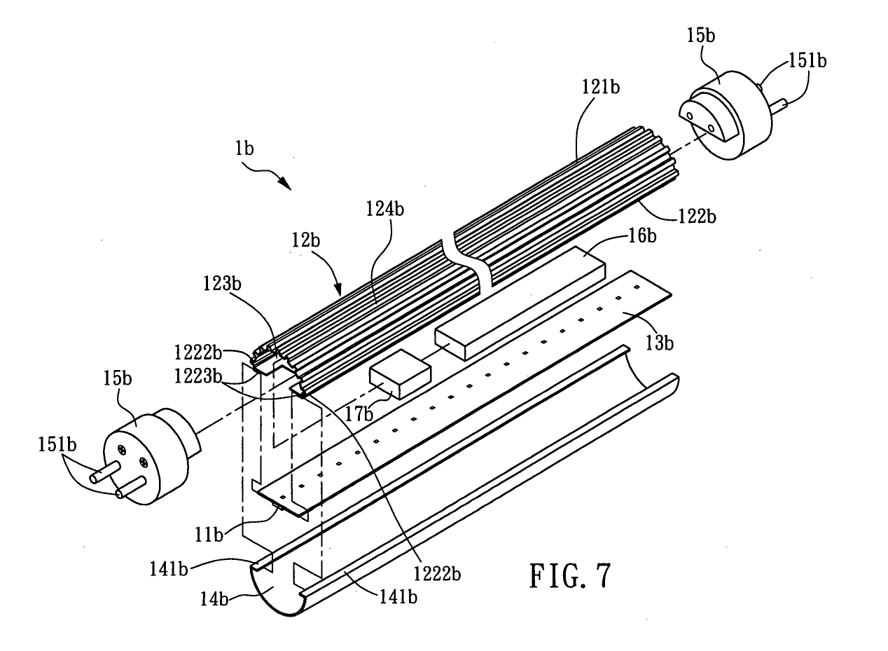

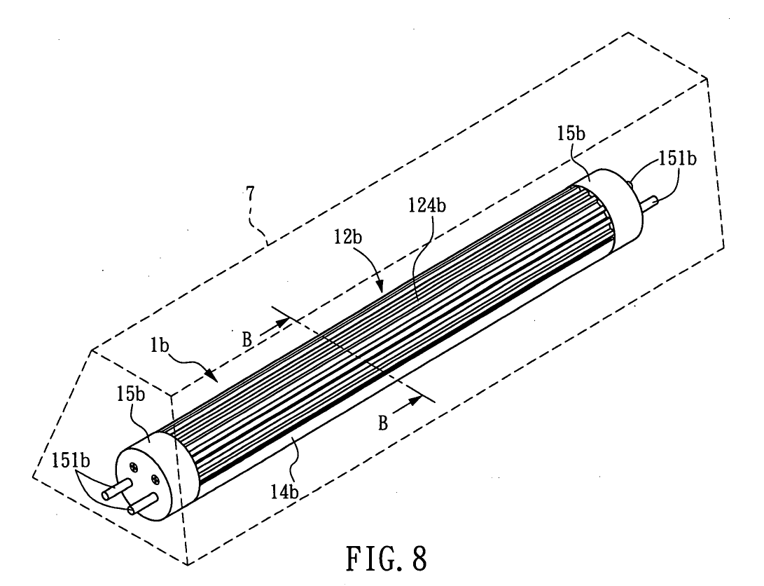

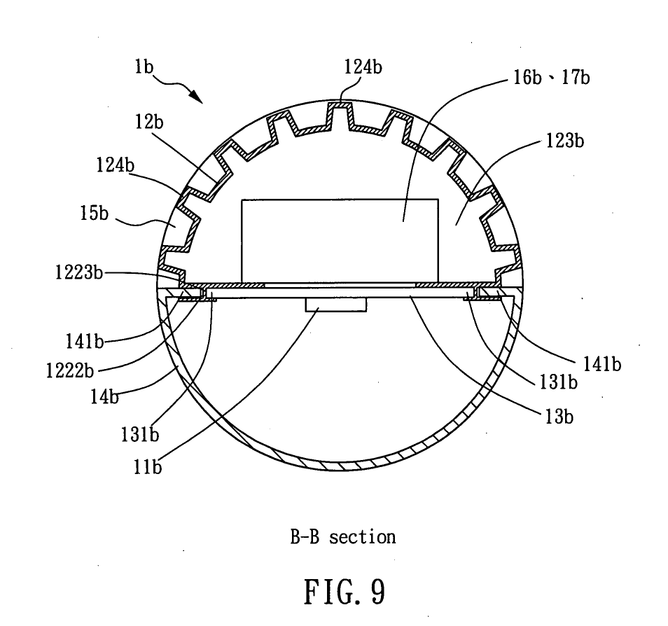

As shown in FIGS. 7, 8 and 9, another embodiment of a lighting apparatus 1b according to the present invention may be applied to a conventional lamp holder 7 (as shown in FIG. 8) to substitute for a traditional tubular lamp. The lighting apparatus 1b has: at least one LED module 11b, a light frame 12b, a base plate 13b, a cover plate 14b, at least two joints 15b, a battery 16b and a power control module 17b. The conventional lamp holder 7 is electrically connected to the grid power source 2 through the power switch 3 (referring to FIG. 5), so as to power the lighting apparatus 1b. While the connection between the conventional lamp holder 7 and the lighting apparatus 1b is known to the art, no further description related thereto will be given herein.

The light frame 12b is formed as a vaulted lengthwise frame, and includes: a top portion 121b, a bottom portion 122b and a hollow portion 123b. The light frame 12b has a bottom portion 122b formed with a pair of first grooves 1223b and a pair of second grooves 1222b. In addition, a top portion 121b of the light frame 12b is formed on its surface with a plurality of sawthoothed sink fins 124b for facilitating the base plate 13b to dissipate the heat generated by the LED module 11b.

The base plate 13b is a metal base plate with at least one circuit loop formed thereon and is configured to allow the LED module 11b to be such installed thereon. The base plate 13b has its two lengthwise edges 131b such coupled with the first groove 1223b at the bottom portion 122b of the light frame 12b that the LED module 11b is placed below the light frame 12b. The thickness of the two lengthwise edges 131b of the base plate 13b substantially fits the width of the first grooves 1223b while the distance between the first grooves 1223b substantially fits the width of the base plate 13b.

The cover plate 14b is formed as such a vaulted lengthwise housing that the assembled light frame 12b and the cover plate 14b form a round tubular shape resembling to a traditional tubular lamp. The cover plate 14b is deposited on the bottom portion 122b of the light frame 12b, and has two lengthwise edges defined as two combining edges 141b for coupling with the second grooves 1222b, so that the base plate 13b is enclosed between the light frame 12b and the cover plate 14b. The cover plate 14b may be a clear, frosted or colored transparent plate. Besides, the length of the cover plate 14b substantially fits the length of the light frame 12b where it is assembled to.

The battery 16b and the power control module 17b are settled in the hollow portion 123b of the light frame 12b and are respectively in electrical connection with the base plate 13b. The two joints 15b are assembled to two ends of the light frame 12b, respectively. Each of the two joints 15b electrically connected to the conventional lamp holder 7 has the conducting properties identical to those of a transitional T8 fluorescent tube and includes two conducting pins 151b that are electrically connected to the power control module 17b and the conventional lamp holder 7, respectively. When assembled, the two joints 15b enclose the base plate 13b fastened with the LED module 11b in the cover plate 14b and enclose the battery 16b and the power control module 17b in the hollow portion 123b.

Since the lighting apparatus 1b uses the high power LED module 11b but not a traditional T8 fluorescent tube, it surpasses the traditional fluorescent lamp by providing more beneficial characteristics, such as long service of more than 30,000 hours, high illuminative efficiency, compliance to CE and UL standards, and energy-saving operation. The lighting apparatus 1b may be alternatively assembled to another G13 conventional lamp holder 7 of specifications of 100V-240V, for housing lighting, commercial lighting and public lighting.

Therein, the battery 16b built in the light frame 12b takes over powering a plurality of LED module 11b on the base plate 13b of the lighting apparatus 1b for a predetermined time period after the grid power source 2 is down for the purpose of emergency illumination. Thus, the lighting apparatus 1b may be detached from the conventional lamp holder 7 and independently used as a portable emergency light or a flashlight. In such case, the built-in battery 16b automatically serves to power the LED module 11b to illuminate. Hence, the lighting apparatus of the present invention is enabled to provide illumination despite the condition of the grid power source 2.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lighting apparatus, comprising:
at least one LED module;
a light frame having a top portion, a bottom portion and a hollow portion, wherein the top portion is provided with a pair of corresponding lengthwise grooves while the bottom portion is provided with a recessed accommodating space and another pair of corresponding lengthwise grooves;
a base plate allowing the LED module to be such installed thereon that the base plate is received in the accommodating space of the light frame and the LED module faces an opening of the accommodating space;
a cover plate deposited on the bottom portion of the light frame and inlaid in the lengthwise grooves of the bottom portion;
a battery received in the hollow portion of the light frame;
a power control module located in the hollow portion of the light frame and electrically connected with the base plate and the battery, respectively, wherein the power control module is connected to an external grid power source so that when the grid power source is down, the power control module automatically uses the battery to take over powering the LED module for emergency illumination; and
at least two end caps assembled to two ends of the light frame so as to enclose the base plate on which the LED module is fixed in the accommodating space of the light frame and enclose the battery in the hollow portion of the light frame.

2. The lighting apparatus of claim 1, further comprising at least one fixture assembly for allowing the lighting apparatus to be fixed to an external wall or an external ceiling, wherein the fixture assembly comprises at least one fixed arm or at least one adjustable arm.

3. The lighting apparatus of claim 2, wherein the fixed arm has two fixing members arranged into a stepped arm including an upper fixing member, a lower fixing member and a connecter, the connecter connected between the upper fixing member and the lower fixing member, the upper fixing member being provided with a fixing hole for a fixing post extending from the ceiling to couple therewith, the lower fixing member being inlaid into the grooves of the top portion, and the fixed arm being allowed to be fastened to the light frame by coupling a screw with a through hole formed on the lower fixing member.

4. The lighting apparatus of claim 2, wherein there are two said adjustable arms coupled with the end caps at the two ends of the lighting apparatus, and each of the adjustable arms comprises a fixing end, a combining end and an adjuster, the fixing end and the combining end being approximately perpendicular to each other, the fixing end being preformed with at least one through hole for allowing the adjustable arm to be fixed to the wall or the ceiling, the combining end being provided with a plurality of positioning holes allowing the adjuster to pass and then couple with a combining hole of the corresponding end cap, in which manner a light-emitting angle of the LED module settled in the light frame and a distance between the light frame and the wall or the ceiling it is attached are both adjustable.

5. The lighting apparatus of claim 1, wherein the cover plate is any one of a convex lens, a concave lens, a plane lens a transparent plate and an optical diffuser plate, and is clear, frosted or colored, the light frame being a lengthwise frame formed through an aluminum extrusion process or an aluminum die-casting process, and the lighting apparatus further comprising a water-block washer sandwiched between any one of the end caps and the light frame for preventing moisture from invading the accommodating space and the hollow portion of the light frame.

6. The lighting apparatus of claim 1, wherein the light frame is formed bilaterally with a plurality of plate-shaped sink fins that are equidistantly spaced and aligned, and the base plate, which is any of a metal base plate and a non-metal printed circuit board, is placed in the accommodating space and attached to the light frame.

7. The lighting apparatus of claim 1, wherein the power control module functions for voltage transformation and current rectification, and comprises:
a first power circuit having an input end directly connected to the grid power source for converting an alternating current into a direct current, there being a capacitor C1 and a resistor R1 connected in parallel and then connected to bridge rectifiers D1˜D4, and the bridge rectifiers D1˜D4 serving to convert the alternating current into the direct current;
a charging circuit stabilizing and filtering the direct current output by the first power circuit so as to charge the battery, and in the charging circuit, there being connected in parallel a resistor R2 for current limitation and a Ziner diode D5 for voltage stabilization, a filter capacitor C2, the battery and a diode D7 that is connected in series at one end of the battery for preventing a reverse current;
a control circuit serving to detect whether the grid power source is down, and if yes, to use the battery a main power source, the control circuit connecting an emitter and a collector of a transistor Q1 with the battery in parallel, the collector of the transistor Q1 being connected in series with a resistor R4, a base of the transistor Q1 being connected with a diode D8 that is connected to an input end of the charging circuit, the base being further connected with a resistor R5 that has another end connected with several divider resistors R6˜R8, a capacitor C3 and a cathode of a Ziner diode D10, the resistor R7 and the capacitor C3 have another ends thereof connected with a diode D9 that is connected to an input end of the charging circuit, the collector of the transistor Q1 being connected to a base of another transistor Q2, and a collector and an emitter of the transistor Q2 being connected to an anode of the Ziner diode D10 and the cathode of the battery, respectively; and
a second power circuit having a layout identical to a layout of the first power circuit, and also serving to convert the alternating current into the direct current, while the second power circuit has an input end connected to the grid power source through the power switch, and has an output end directly connected to the LED module on the base plate.

8. A lighting apparatus for being installed onto a lamp holder, the lighting apparatus comprising:
at least one LED module;
a light frame having a top portion, a bottom portion and a hollow portion, wherein the bottom portion is provided with a pair of corresponding first grooves and a pair of corresponding second grooves;
a base plate allowing the LED module to be installed thereon and inlaid in the first grooves at the bottom portion of the light frame so as to place the LED module below the light frame;
a cover plate deposited on the bottom portion of the light frame and inlaid in the second grooves;
a battery settled in the hollow portion of the light frame;
a power control module settled in the hollow portion of the light frame and electrically connected to the base plate and the battery, respectively, for voltage transformation and current rectification; and
at least two joints assembled to two ends of the light frame, each having two conducting pins and electrically connected to the power control module, and serving to enclose the base plate in the cover plate and enclose the battery in the hollow portion;
wherein, when assembled together, the light frame and the cover plate jointly form a round tubular shape.

9. The lighting apparatus of claim 8, wherein the light frame is a lengthwise frame formed through an aluminum extrusion process or an aluminum die-casting process, and the top portion of the light frame is constructed from a plurality of sawthoothed sink fins.

10. The lighting apparatus of claim 8, wherein the power control module is connected to an external grid power source so that when the grid power source is down, the power control module automatically uses the battery to take over powering the LED module for emergency illumination; and
wherein the power control module functions for voltage transformation and current rectification, and comprises:
a first power circuit having an input end directly connected to the grid power source for converting an alternating current into a direct current, there being a capacitor C1 and a resistor R1 connected in parallel and then connected to bridge rectifiers D1˜D4, and the bridge rectifiers D1˜D4 serving to convert the alternating current into the direct current;
a charging circuit stabilizing and filtering the direct current output by the first power circuit so as to charge the battery, and in the charging circuit, there being connected in parallel a resistor R2 for current limitation and a Ziner diode D5 for voltage stabilization, a filter capacitor C2, the battery and a diode D7 that is connected in series at one end of the battery for preventing a reverse current;
a control circuit serving to detect whether the grid power source is down, and if yes, to use the battery a main power source, the control circuit connecting an emitter and a collector of a transistor Q1 with the battery in parallel, the collector of the transistor Q1 being connected in series with a resistor R4, a base of the transistor Q1 being connected with a diode D8 that is connected to an input end of the charging circuit, the base being further connected with a resistor R5 that has another end connected with several divider resistors R6˜R8, a capacitor C3 and a cathode of a Ziner diode D10, the resistor R7 and the capacitor C3 have another ends thereof connected with a diode D9 that is connected to an input end of the charging circuit, the collector of the transistor Q1 being connected to a base of another transistor Q2, and a collector and an emitter of the transistor Q2 being connected to an anode of the Ziner diode D10 and the cathode of the battery, respectively; and
a second power circuit having a layout identical to a layout of the first power circuit, and also serving to convert the alternating current into the direct current, while the second power circuit has an input end connected to the grid power source through the power switch, and has an output end directly connected to the LED module on the base plate.

11. A lighting apparatus, comprising:
at least one LED module;
a light frame having a recessed accommodating space;
a base plate allowing the LED module to be installed thereon and being received in the accommodating space of the light frame so that the LED module faces an opening of the accommodating space;
a cover plate deposited on the bottom portion of the light frame;
a battery settled in the light frame;
a power control module settled in the light frame and electrically connected to the LED module on the base plate and the battery, respectively, for voltage transformation and current rectification, wherein the power control module is connected to an external grid power source so that when the grid power source is down, the power control module automatically uses the battery to take over powering the LED module for emergency illumination; and
at least two end caps assembled to two ends of the light frame.

12. The lighting apparatus of claim 11, wherein the power control module functions for voltage transformation and current rectification, and comprises:
a first power circuit having an input end directly connected to the grid power source for converting an alternating current into a direct current, there being a capacitor C1 and a resistor R1 connected in parallel and then connected to bridge rectifiers D1˜D4, and the bridge rectifiers D1˜D4 serving to convert the alternating current into the direct current;
a charging circuit stabilizing and filtering the direct current output by the first power circuit so as to charge the battery, and in the charging circuit, there being connected in parallel a resistor R2 for current limitation and a Ziner diode D5 for voltage stabilization, a filter capacitor C2, the battery and a diode D7 that is connected in series at one end of the battery for preventing a reverse current;
a control circuit serving to detect whether the grid power source is down, and if yes, to use the battery a main power source, the control circuit connecting an emitter and a collector of a transistor Q1 with the battery in parallel, the collector of the transistor Q1 being connected in series with a resistor R4, a base of the transistor Q1 being connected with a diode D8 that is connected to an input end of the charging circuit, the base being further connected with a resistor R5 that has another end connected with several divider resistors R6˜R8, a capacitor C3 and a cathode of a Ziner diode D10, the resistor R7 and the capacitor C3 have another ends thereof connected with a diode D9 that is connected to an input end of the charging circuit, the collector of the transistor Q1 being connected to a base of another transistor Q2, and a collector and an emitter of the transistor Q2 being connected to an anode of the Ziner diode D10 and the cathode of the battery, respectively; and
a second power circuit having a layout identical to a layout of the first power circuit, and also serving to convert the alternating current into the direct current, while the second power circuit has an input end connected to the grid power source through the power switch, and has an output end directly connected to the LED module on the base plate.

13. The lighting apparatus of claim 11, further comprising at least one fixture assembly for allowing the lighting apparatus to be fixed to an external wall or an external ceiling, wherein the fixture assembly comprises at least one fixed arm or at least one adjustable arm.

14. The lighting apparatus of claim 13, wherein the fixed arm has two fixing members arranged into a stepped arm including an upper fixing member, a lower fixing member and a connecter, the connecter connected between the upper fixing member and the lower fixing member, the upper fixing member being provided with a fixing hole for a fixing post extending from the ceiling to couple therewith, the lower fixing member being inlaid into the grooves of the top portion, and the fixed arm being allowed to be fastened to the light frame by coupling a screw with a through hole formed on the lower fixing member.

15. The lighting apparatus of claim 13, wherein there are two said adjustable arms coupled with the end caps at the two ends of the lighting apparatus, and each of the adjustable arms comprises a fixing end, a combining end and an adjuster, the fixing end and the combining end being approximately perpendicular to each other, the fixing end being preformed with at least one through hole for allowing the adjustable arm to be fixed to the wall or the ceiling, the combining end being provided with a plurality of positioning holes allowing the adjuster to pass and then couple with a combining hole of the corresponding end cap, in which manner a light-emitting angle of the LED module settled in the light frame and a distance between the light frame and the wall or the ceiling it is attached are both adjustable.

16. The lighting apparatus of claim 13, wherein the cover plate is any one of a convex lens, a concave lens, a plane lens a transparent plate and an optical diffuser plate, and is clear, frosted or colored, the light frame being a lengthwise frame formed through an aluminum extrusion process or an aluminum die-casting process, and the lighting apparatus further comprising a water-block washer sandwiched between any one of the end caps and the light frame for preventing moisture from invading the accommodating space and the hollow portion of the light frame.

17. The lighting apparatus of claim 13, wherein the light frame is formed bilaterally with a plurality of plate-shaped sink fins that are equidistantly spaced and aligned, and the base plate, which is any of a metal base plate and a non-metal printed circuit board, is placed in the accommodating space and attached to the light frame.

18. The lighting apparatus of claim 11, wherein each of two ends of the lighting apparatus is provided with a joint, which has two conducting pins and is electrically connected to the power control module, the joints serving to enclose the base plate in the cover plate and enclose the battery in the hollow portion, and when assembled, the light frame and the cover plate jointly forming a round tubular shape.
